(19) United States
(12) Patent Application Publication
(10) Pub. No.: US 2018/0002564 A1
(43) Pub. Date: Jan. 4, 2018

(54) AQUEOUS POLYMER COMPOSITIONS AND METHODS

(71) Applicant: GAPA Enterprises, Memphis, TN (US)

(72) Inventor: GREGG R. OVERMAN, Hernando, MS (US)

(73) Assignee: GAPA Enterprises, Memphis, TN (US)

(21) Appl. No.: 15/354,776

(22) Filed: Nov. 17, 2016

Related U.S. Application Data
(60) Provisional application No. 62/356,394, filed on Jun. 29, 2016.

(51) Int. Cl. C09D 167/08; C09D 7/00; C09D 5/02; C09F 9/00

(52) U.S. Cl. CPC C09D 167/08; C09F 9/00; C09D 7/002; C09D 5/022; C09D 5/025; C09D 5/024; C09D 5/028

(57) ABSTRACT

Aqueous alkyd resin emulsion compositions and methods of applying them for providing an exceptionally durable film capable of imparting a gloss sheen to the substrate while simultaneously entrapping pigments, MYLAR or glitter flakes, or other low aspect ratio materials so that they might durably adhere to a variety of surfaces, including, but not limited to, urethane rubber, vehicle tires, and vinyl. The emulsion compositions comprise an alkyd resin, a mixture of alkyd resins, a mixture of alkyd resins and conventional latex resins, or a mixture of all or part of the above and silicone oils. The low aspect ratio materials component of the compositions may be comprised of any combination of various pigments, MYLAR or metallic flakes, or standard glitter flakes, all in a wide variety of sizes, colors and shapes. The emulsion compositions also optionally comprise thickeners, metallic driers, defoamers, and/or preservatives. The methods comprise applying the alkyd resin emulsion composition with low aspect ratio materials to a substrate surface.

### CROSS REFERENCE TO RELATED APPLICATIONS

This application claims priority to U.S. Provisional Application No. 62/356,394 to Gregg Overman filed Jun. 29, 2016, and which is incorporated herein by reference in its entirety.

### FIELD OF THE INVENTION

The present invention is generally directed toward compositions and methods related to water-borne polymer compositions and more specifically to water-borne, film-forming alkyd resin coatings that adhere, in a durable fashion, pigments and/or other particles such as glitter or other colored pieces of low aspect ratio material.

### BACKGROUND OF THE INVENTION

The search for methods to preserve substrates from the depredations of wind, rain, sun, and microbial attack predates the recorded history of mankind. Perhaps the oldest is the use of simple oils, tars, and waxes to lend water repellency to wood and clothing. There are today literally thousands of products to choose from; each having particular strengths and weaknesses. However, some surfaces in need of protection or desirable of maintaining a “new” or “shiny” appearance have not been successfully treated with film-curing protectants.

One category of surfaces commonly treated is polymers, such as rubber vehicle tires and other polymer surfaces, including vinyl plastics. Numerous products are on the market that claim to provide gloss or sheen to vehicle tires and vinyl plastics. These can be broadly divided into two types: those that are temporary in nature and those that purport to be more durable or long lasting. The most common of the “temporary” tire shine/vinyl products are typically mixtures of silicone oils having viscosities from 100 centistokes to well over 10,000 centistokes. These are available as water-borne emulsions and solvent-borne solutions. Other temporary tire shine products can be made using polyethylene and/or polypropylene glycols of various molecular weight distributions. Tire shine/vinyl rejuvenation products have also been successfully produced using various natural gums dissolved in different solvents. All of these temporary treatment products function by filling in small dips and pinholes in the surface and then slumping or leveling to produce an optically flat surface. However, none of them will cure to form a film on the surface. After the solvent or water has evaporated, the products remain on the surface as high viscosity liquids. This brings with it the many problems inherent in this approach. The resulting high viscosity liquid is both sticky and mobile. The sticky nature of the liquid causes it to pick up and hold dust and dirt, resulting in a degraded appearance to the treated surface. Even if this does not occur, the high viscosity liquid can continue soak into the surface or be slung off from a tire due to centrifugal forces acting on the tire when driving. In some cases, such as the silicone products, the liquid itself can slowly evaporate over a period of a few days. In all cases these products will be removed when the vehicle is next washed. The net result is a need to reapply the treatment every few days in order to preserve the appearance desired by many consumers. Furthermore, the “sling off” of material from centrifugal forces is not a small issue. Not only does it remove the product from the tire and lessen the desirable appearance, the resulting deposition of the tire shine product on wheel wells, fenders, and body panels causes unsightly and difficult to remove stains on these surfaces. There are also numerous products on the market that claim to leave a durable gloss or shine on vehicle tires. The reason these have not displaced the more temporary products in the marketplace is that they all suffer from one problem or another, such as: difficulties in application; the need to wait for several minutes or even hours between application and driving the vehicle; noxious and dangerous solvent carriers; cracking, peeling, and flaking from the tires; and, paradoxically, lack of longevity.

There are very few products on the market which claim to enable the application of “glitter” or low aspect ratio particles to vehicle tires. No such product is known for application of glitter or low aspect ratio particles to exterior vinyl or urethane rubber. The product “TIRE COLOR” sold by Black Magic is the only product known for application of glitter to vehicle tires. TIRE COLOR suffers from a number of problems. Although the product is claimed to be durable, it is openly described as a “washable tire coating.” It also suffers from being a two-step application, requiring a sponge application of the glitter followed by a separate spray application of a product in order to affix the glitter to the vehicle tire and also to lend a shine or gloss to the vehicle tire.

### SUMMARY OF THE INVENTION

The present invention provides methods to apply, in one step, dyes, pigments, mica, holographic pigments, pearlescent pigments, glitter, colored and/or metallic MYLAR flakes, and/or other low aspect ratio material particles while simultaneously achieving a shine, gloss or “new tire” look to urethane rubber, vehicle tires, and vinyl surfaces. Both glossy shine and the low aspect ratio material particles (e.g., glitter, pigment, and/or MYLAR flakes) will be durably adherent and resistant to removal by washing with water and soap while avoiding most, if not all, of the problems currently associated with the “tire wet” technology as it exists today. The present invention is comprised of an aqueous alkyd resin composition in combination with various pigments, colored or metallic MYLAR flakes, and/or other low aspect ratio material particles. The resin portion of the compositions, when applied to a vehicle tire or to vinyl, will soak into the surface and cure to a flexible and resilient film by oxidative polymerization, allowing it to tightly adhere to the tire. This film, by virtue of its mechanical properties will lend a shine, gloss or “new tire” look to the vehicle tires and or vinyl which will last up to eight weeks and will resist removal by ordinary washing with soap and water. This resin film will also entrap and hold pigments, colored or metallic MYLAR flakes, and/or other low aspect ratio material particles to the vehicle tire or vinyl for substantial lengths of time and will resist removal of these materials from the vehicle tire by ordinary washing with soap and water. The compositions, once cured, furthermore produce a film that, by virtue of its ability to soak into and penetrate the urethane rubber or tire surface, will not “sling off” of the tire under ordinary driving circumstances.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may he applied to other embodiments and applications without departing from the scope of the invention. The present invention is not intended to be limited to the embodiments shown, but is to be accorded the widest possible scope consistent with the principles and features disclosed herein.

In 2008, Reichhold Chemical commercialized a true alkyd emulsion coatings resin under the trade name BECKOSOL. This material, for the first time, combined the superior penetrating ability of alkyd resins with the advantages of latex emulsions. The novel exploitation of these alkyd resin emulsions and the resultant unique film properties form the basis of this disclosure. Although Reichhold was the first to market with the alkyd resin technology, several other producers are now supplying similar materials. The alkyd resins used herein may be based on long, medium, or short oil alkyds, or combinations thereof. The alkyds used herein may include alkyd resins with epoxy, acrylic, urethane, styrene, vinyl ester, vinyl ether, silicone, or any number of other types of modifications known in the art, including combinations thereof.

The use of alkyd emulsions has not been fully explored for many surface treatment applications, and has never been explored as a component of urethane rubber, vehicle tire, and vinyl treatment compositions and methods of providing a durable shine or “new” look to urethane rubbers, rubber tires, and vinyl plastics. Further, the use of alkyd emulsions has never been explored as a component of compositions designed to adhere dyes, pigments, glitter, or other low aspect ratio particles a plurality of particles having a very small size in at least one dimensional plane—e.g., common glitter having a small height dimension, but having larger width and length dimensions—and for ease of terminology, these component additives can be referred to herein together simply as “low aspect ratio materials”) to vehicle tires, urethane rubber, or vinyl surfaces. My research has shown that the ability of my alkyd emulsion-based compositions to penetrate (absorb into) and adhere to (adsorb onto) a substrate surface to cure to a hard, resilient film imparts unique properties to urethane rubber, tire rubber, and vinyl treatment compositions. The resilience of the cured film allows for the compositions to be applied to and maintain a durable shine or gloss to vehicle tires and vinyl and to durably adhere a variety of particles including dyes and pigments, MYLAR flakes (or other shiny plastic or metallic flakes or material with a metallic appearance like a “glitter,” which may be any color), and other low aspect ratio particles (i.e., low aspect ratio materials). I have found that embodiments of my alkyd emulsion-based compositions can be utilized to, without limitation, provide an exceptionally durable glossy sheen on and adhere pigments and/or particles to even the most difficult and flexible of surfaces such as vehicle tires and vinyl plastics. Other materials, e.g., brick, concrete, wood, etc., can also be treated with the inventive compositions o provide an exceptionally durable glossy sheen and adherence of pigments and/or particles (i.e., low aspect ratio materials). Furthermore, some embodiments of my alkyd emulsion-based compositions can be utilized to, without limitation, (1) provide structural support to the top layer of a variety of substrates (e.g., brick, concrete, wood, rubber, etc.); (2) provide extreme exterior durability to a variety of substrates (e.g., brick, concrete, wood, rubber, etc.) in the face of weather and other physical contacts (rain, sleet, snow, hail, foot traffic, etc.); (3) provide exceptional long-term water repellency to a variety of substrates (e.g., brick, concrete, wood, rubber, etc.); (4) provide exceptional long-term mold, mildew, and algae control in and on the cured film on and within a variety of substrates (e.g., brick, concrete, wood, rubber, etc.).

Described here is a particularly preferred embodiment of an alkyd film-forming composition of the present invention for providing an exceptionally durable glossy sheen to a surface and/or adherence of pigments and/or particles (i.e., low aspect ratio materials) thereto, a long oil alkyd resin emulsion such as BECKOSOL AQ 101 or an acrylic modified alkyd resin emulsion such as BECKOSOL AQ 510 is used at a concentration from 5% to 95% by weight and more preferably at a rate from 25% to 80% by weight in combination with a plurality of at least one low aspect ratio material, which may be selected from various pigments, MYLAR flakes (or other shiny flakes or material with a metallic appearance like a “glitter”), or other low aspect ratio particles, and combinations thereof, combined with the alkyd emulsion at a concentration of 0.1% to 50% by weight but preferably at a concentration of 0.5% to 10% by weight based on total formula weight. My research has shown BECKOSOL AQ 510 to have great utility on rubber urethane) surfaces and vinyl plastic surfaces, and, therefore, is the preferred resin base component for treating and/or protecting these types of material surfaces. A small amount (from 0.05% to 1.0% by weight) of a cellulosic thickener, such as hydroxyethyl cellulose or hydroxypropyl cellulose, is added for viscosity control; the target value being in the range of 50 to 50,000 centipoise as measured using a Brookfield RV viscometer at 20 RPM with the appropriate spindle (how to use an appropriate spindle is well-known in the art, e.g., #1 for ranges around 50 centipoise and #6 for ranges around 50,000 centipoise). A metallic drier suitable for aqueous systems, preferably BORCIII OXY-COAT from OMG Borchers, is incorporated at a rate of 0.1% to 3% of the weight of the alkyd emulsion as supplied in the composition. Other metallic driers known in the art (for example, cobalt, zirconium, manganese, calcium, zinc, copper, barium, vanadium, cerium, iron, potassium, strontium, aluminum, bismuth and lithium-containing compounds) can be adapted by a person of skill in the art based on the composition components and the substrate to be treated. Known, non-metallic driers are not preferred, but can be adapted for use in the compositions by a person of ordinary skill in the art without undue experimentation. A defoamer suitable for aqueous systems may be added at a rate of 0.01% to 1.0% by weight of total batch size. An in-can preservative, such as Dow Chemical Company's BIOBAN 536, should be used at the level recommended by the manufacturer to insure stability of the product prior to application. The balance of the formula being water.

There are a number of BECKOSOL resins. BECKOSOL AQ 201, BECKOSOL AQ 206, BECKOSOL AQ 400, BECKOSOL AQ 521 and other resins within this class of products, as well as analogues to these materials produced by manufactures other than Reichhold, may be used within the compositions and methods of the present invention, including for providing an alkyd resin film on rubber and vinyl plastic surfaces, as well as other material surfaces, to give an exceptionally durable glossy sheen to such surfaces and/or adherence of pigments and/or particles thereto. My research has shown BECKOSOL AQ 101 to be preferable on wood surfaces, while BECKOSOL AQ 510 to have great utility on cementitious and rubber (urethane) surfaces. A person skilled in the art can use standard laboratory techniques to determine the advantages of these resins in a chosen application and/or a desired performance when applied to rubber (urethane), vehicle tires, or vinyl plastic surfaces, as well as other material surface types, following the present disclosure to give an exceptionally durable glossy sheen to such surfaces and/or adherence of pigments and/or particles thereto.

Thus, a person of skill in the art will appreciate that, depending on the rubber or vinyl surface (or other surface material) to be treated to give an exceptionally durable glossy sheen to such surfaces and/or adherence of pigments and/or particles thereto, the particular resin base component chosen will provide different and/or better sheen and/or protectant characteristics. These or other alkyd resin emulsion base components may be used in compositions for treating and/or protecting other substrates (such as, and by way of example only: stone/masonry, tile, or fabric), which a person of skill in the art can readily determine following the teachings in this disclosure and with standard laboratory evaluation techniques. In practice, any of several different alkyd resin emulsions, mixtures of alkyd resin emulsions, or mixtures of alkyd resin emulsions and other commonly used latex emulsions, as well as mixtures of any of the above with the commonly used silicone oils and gums used in traditional tire and vinyl treatments may be used to achieve optimum performance of an embodiment of the alkyd resin compositions of the invention in polymer surface applications. In some embodiments, no unmodified short oil alkyd is used. In other embodiments, modified short oil alkyd is used. In further embodiments, unmodified long oil alkyds, unmodified medium oil alkyds, and combinations thereof are used. In still other embodiments, modified long oil alkyds, modified medium oil alkyds, and combinations thereof are used. In yet further embodiments, unmodified long oil alkyds, unmodified medium oil alkyds, modified long oil alkyds, modified medium oil alkyds, modified short oil alkyds, and combinations thereof are used.

My research has shown that the alkyd emulsion solids must comprise at least 30%, preferably 80%, and more preferably greater than 80%, of the overall coating solids in order to achieve the desired coating properties which will depend on the substrate to be treated among other considerations known in the industry. A person of skill in the art will understand that the “optimum performance” for the disclosed alkyd resin compositions will depend on the given application and its particularities, such as the particular type of particle being entrapped in the resin and the amount of durable sheen desired. In general, smaller particles will be adequately adhered to the tire with lower resin solids. Higher solids content will better hold larger particles to the tire and will also give a higher gloss to the tire. However, each case must be evaluated on its own merits and the markets to which the product is being addressed. These considerations can be evaluated by a person of skill in the art using well-known and routine laboratory techniques.

The choice of pigments (any substance that provides a color or tint to the cured composition film, e.g. titanium dioxide, mica, calcium carbonate, silica, zinc oxide, milled glass, aluminum trihydrate, talc, silica oxide, alumina, zirconia, antimony trioxide, fly ash, clay, carbon black, pearlescent pigments, holographic pigments, and colorants/coloring agents; as a yellow coloring agent, compounds typified by a condensed azo compound, an isoindolynone compound, an anthraquinone compound, an azometal complex methine compound, and an allylamide compound as pigments may be used; as a magenta coloring agent, a condensed azo compound, a diketopyrrolopyrrole compound, anthraquinone, a quinacridone compound, a base dye lake compound, a naphthol compound, a benzimidazolone compound, a thioindigo compound, and a perylene compound may be used; as a cyan coloring agent, a copper phthalocyanine compound and its derivative, an anthraquinone compound, a base dye lake compound; any combination of the foregoing, and the like may be used), glitter (such as MYLAR flakes or other shiny flakes or material with a metallic appearance like a “glitter” or the same that have been painted), or other low aspect ratio materials can vary widely. My research has shown good effects using so-called pearlescent pigments, metallic pigments, “color flop” pigments (such as pigments commonly used in vehicle paint with characteristics of a color change based on lighting and angle of sight), and combinations thereof. However, interesting and potentially marketable effects can be achieved when using standard glitter flakes, such as can be purchased at any hobby store in a wide variety of sizes, colors, and shapes. In practice, any material of a size and shape such that it can be affixed to a vehicle tire or vinyl surface by effectively being covered and encapsulated by the cured resin composition film and, therefore, protected from removal by wind, rain, and soap and water washing can be used for changing the appearance of the vehicle tire or vinyl in a manner that is pleasing and desirable to a consumer.

The cellulosic thickeners above may be substituted with associative thickeners, acrylate, gum, clay, or other known and compatible thickeners or rheology modifiers, or combinations of these may be used, and are referred to collectively as thickening agents. More or less than the preferred range of from 0.05% to 1.0% by weight may be used in order to achieve the target value range of 50 to 50,000 centipoise as measured using a Brookfield RV viscometer at 20 RPM with the appropriate spindle.

In some embodiments, thickeners and/or rheology modifiers may be omitted as unnecessary additives. A person of skill in the art will understand that the type and amount of thickener, when used in different embodiments, will depend on the substrate/application at issue, as well as other considerations such as to improve application/composition flow and customer perception. Further routine experimental investigation may be required by a person of ordinary skill in the art following the teachings provided herein and standard methods in the field in order to achieve the appropriate rheology for any given system and application.

Biocides may be included for prolonging the storage and/or application container(s) or for the prevention of mildew, mold, algae, or other undesirable microbial growth in and on the cured film in an application. Acceptable biocides are well-known to those skilled in the art. An appropriate amount of a biocide (from 0.1 to 2.0%), such as Troy's POLYPHASE 678, is added in some embodiments for control of mildew, mold, and other microorganisms in and on the cured film. The amount of biocide will depend on a number of factors, including type, potency, and spectrum of biocide activity. Preferred biocides include POLYPHASE (3-iodo-2-propynyl butyl carbamate) in any of several forms and compositions available from Troy Chemical, various borate compositions (e.g., zinc borate), and the AMICAL or BIOBAN lines of products available from Dow Chemical. A person of skill in the art will recognize that these and many other biocides are available to paint and resin chemists, and any known and acceptable biocide may or may not be used either alone or in combination, as deemed necessary for a given composition and/or its application.

The general application goal in which the alkyd resin compositions and pigment, glitter flakes, or other low aspect ratio materials of the present invention may be of particular utility is to provide a gloss or sheen to a surface while simultaneously affording durable adhesion of the aforementioned pigment, glitter flakes, or other low aspect ratio materials, all to a variety of substrates: especially vehicle tires, all types of rubber, urethane, and vinyl plastics, in order to enhance the visual appeal of these surfaces, but this statement should be understood to not be limiting to the full scope of the present invention. The present invention furthermore produces a film that, by virtue of its ability to soak into and penetrate the surface (e.g., urethane rubber or vehicle tire surface), will not “sling off” of the tire due to centrifugal forces under ordinary driving circumstances.

It will be understood by a person of skill in the art that in applications where a pigmented system is desired, the grind phase of the actual production will include various known dispersants and/or grinding resins. It is common practice to add a small amount (0.05% to 1.0%) of the grind weight of an appropriate in-process defoamer such as TROYKYD D230 at some point in the grind stage. The choice of dispersants and/or grinding resins will be determined by the pigments being ground and the total pigment loading but might include dispersants such as the TAMOL series from Dow Chemical or some of the SUPERSPERSE products from Eagle Specialty Products. Grinding resins could include members of the TEXICRYL line of products from Scott Bader Specialty Polymers or AROLON 845-W-45 from Reichhold. Titanium dioxide and various iron oxides or other metal oxides, as well as many other inorganic and organic pigments, may be added to the grind phase. Applications to wood will greatly benefit from the inclusion of pigments in order to mitigate e destructive effects of ultra violet light. In many cases, exterior cementitious surfaces such as driveways or stucco will be pigmented to please the consumer. Applications to asphalt will generally require a lamp black or carbon black pigment to enhance the appearance of the coated surface. Applications to vehicle tires, interior stone, or masonry and fabric will, in general, be applied as a clear product without pigment. In some embodiments for vehicle tires where pigmentation is desirable, at least one pigment selected from various colors may be included as the pigment component. Unless otherwise specified by the supplier, the water repellent and the biocide (either in-can or for inhibition of microbial growth in the cured film) will be added to the letdown phase of production.

The letdown phase of production will include the alkyd emulsion and other additives (whether required or optional). These additives could include the biocide and/or the water repellency agent, as well as any wetting agents or rheological additives. In some cases, pre-dispersed pigments may be purchased from any number of suppliers, including Eagle Specialty Products, Chromatech, BASF, and many others. Prepackaged pigment dispersions are generally used when the pigment is difficult to grind or difficult to handle, such as carbon black, various transparent iron oxides, many organic pigments such as phthalocyanine pigments and any pigments supplied in particle sizes below 3 microns. Prepackaged pigment dispersion should, in general, be added in the letdown phase. It is common practice to add an appropriate defoamer such as a polysiloxane or fumed silica composition at the end of the letdown stage for control of foam during product application.

The alkyd resin compositions of the present invention may exhibit high gloss on some substrate surfaces. In preferred embodiments, especially for applications of treating and/or protecting rubber, vehicle tire, and vinyl plastic surfaces, the glossy sheen of some compositions, once cured on and within the substrate, is resistant to water and soap washing. I have found that the durability of the glossy sheen on rubber tire surfaces, in one embodiment, can last for up to a month (28 days), eight weeks (56 days), or more. Additional agents, such as standard latex, may be included to enhance gloss in some applications. It should be understood, however, that there are applications where gloss is a detriment or otherwise undesirable. In these applications, various flatting agents such as fumed or precipitated silicas or certain known waxes may be used to reduce the gloss of the dried film.

For applications where greater water repellency is desired in the cured film, a water repellency agent may further provide some enhanced durability characteristics to the cured resilient film. A person of skill in the art will recognize that such desirability will depend on the intended application of any given alkyd resin composition of the present invention. A paraffin wax emulsion (from 0.5% to 5.0%), such as Michelman's MICHEM Emulsion products is added in some embodiments as a water repellency agent. A particularly preferred paraffin wax emulsion is ME 70158 from Michelman. However, it will be understood that some embodiments will use a different or no water repellency agent. Water repellency agents, such as paraffin, slack wax, or other wax in the aqueous emulsions, either anionic, nonionic, or cationic, are thus optional in general, but may be required for certain intended applications that benefit from water repellency. Other acceptable water repellency agents include various known silicone oils and/or siloxanes, various known fluoro-surfactants and fluoropolymers, as well as known powdered waxes (such as carnauba) or the afore-mentioned waxes may be used either alone or in combination with other known water repellent additives (either natural or synthetic) to achieve the desired water repellency characteristics for a given alkyd resin composition of the present invention and its intended application (material type surface). Those who are skilled in the art will understand that each substrate will respond differently to different water repellant agents and that in each case some routine investigation will he necessary in order to choose the most effective water repellent agent for maximum water repellency and longevity. For applications where water repellency is not critical for performance, a water repellency agent can be omitted.

The method of application will vary depending on the substrate surface in need of treatment and the exact composition being applied. My investigation has shown that the preferred method is pouring the inventive compositions on to a soft cloth or sponge with subsequent spreading of the product using the soft cloth or sponge to evenly distribute the material on the surface. My research has shown that some instances of the inventive compositions comprising small particle size pigments may be sprayed with a mechanical (trigger or pump-up) sprayer and subsequently spreading the product using a soft cloth or sponge to evenly distribute the material on the surface. In all cases, efforts should be made to insure an even application, and any obvious pools of excess liquid product should be wiped up before the product has begun to dry (two to ten minutes depending on humidity, temperature, substrate surface, and the composition being used). For application to other substrates, the compositions may be rolled, brushed, sprayed (either mechanical or pump-up) or other method conventionally employed to apply a coating to a substrate in the industry. After application, compositions cure by oxidative polymerization on and within the surface.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit, and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all sub-ranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

I claim:

1. An aqueous emulsion composition comprising an alkyd resin, a drier, and a plurality of at least one low aspect ratio material.

2. The aqueous emulsion composition of claim 1 further comprising a thickening agent.

3. The aqueous emulsion composition of claim 2, wherein the thickening agent is in the range of 0.05% to 1.0% by weight of the total aqueous emulsion composition.

4. The aqueous emulsion composition of claim 3, wherein the thickening agent is a cellulosic thickener.

5. The aqueous emulsion composition of claim 3, wherein the thickening agent is an associative thickener.

6. The aqueous emulsion composition of claim 3, wherein the thickening agent is a clay.

7. The aqueous emulsion composition of claim 3, wherein the thickening agent is a gum.

8. The aqueous emulsion composition of claim 2, wherein the aqueous emulsion composition viscosity is in the range of 50 to 50,000 centipoise.

9. The aqueous emulsion composition of claim 1, wherein the at least one low aspect ratio material is in the range of 0.1% to 50% by weight of the total aqueous emulsion composition.

10. The aqueous emulsion composition of claim 1, wherein the at least one low aspect ratio material is a pigment.

11. The aqueous emulsion composition of claim 1, wherein the at least one low aspect ratio material is a glitter.

12. The aqueous emulsion composition of claim 11, wherein the glitter is selected from the group consisting of MYLAR flakes, plastic flakes, metal flakes, and painted flakes.

13. The aqueous emulsion composition of claim 1, wherein the alkyd resin comprises 30% to 80% of the total solids content of the aqueous emulsion composition.

14. The aqueous emulsion composition of claim 1, wherein the alkyd resin comprises greater than 80% of the total solids content of the aqueous emulsion composition.

15. The aqueous emulsion composition of claim 1, wherein the alkyd resin is selected from the group consisting of a short oil alkyd resin, a medium oil alkyd resin, a long oil alkyd resin, a modified alkyd resin, and combinations thereof.

16. The aqueous emulsion composition of claim 15, wherein the modification of the alkyd resin is selected from the group consisting of epoxy, acrylic, urethane, styrene, vinyl ester, vinyl ether, silicone, and combinations thereof.

17. The aqueous emulsion composition of claim 1, wherein the alkyd resin is a long oil alkyd resin.

18. The aqueous emulsion composition of claim 1, wherein the alkyd resin emulsion is a medium oil alkyd resin emulsion.

19. The aqueous emulsion composition of claim 1, wherein the alkyd resin emulsion is a short oil alkyd resin emulsion.

20. The aqueous emulsion composition of claim 1, wherein the alkyd resin is an acrylic modified alkyd resin.

21. The aqueous emulsion composition of claim 20, wherein the acrylic modified alkyd resin component is in an emulsion.

22. The aqueous emulsion composition of claim 21, wherein the acrylic modified alkyd resin emulsion is in the range of 5% to 95% by weight of the total aqueous emulsion composition.

23. The aqueous emulsion composition of claim 1 further comprising a latex emulsion comprising at least one latex resin.

24. The aqueous emulsion composition of claim 1 further comprising an additive selected from the group consisting of a defoamer, a silicone oil, a siloxane, a gum, a fluorosurfactant, a fluoropolymer, a biocide, a wax, and combinations thereof.

25. The aqueous emulsion composition of claim 1, wherein the drier is a metallic drier.

26. The aqueous emulsion composition of claim 1, wherein the drier is a non-metallic drier.

27. A method of forming a film coating on a surface, comprising: applying to the surface an aqueous emulsion composition comprising an alkyd resin, a drier, and a plurality of at least one low aspect ratio material.

28. The method of claim 27, wherein the surface is selected from the group consisting of a vehicle tire surface, a rubber surface, and a vinyl surface.

29. The method of claim 27, wherein the aqueous emulsion composition cures to a resilient film on the surface.

30. The method of claim 29, wherein the aqueous emulsion composition encases the at least one low aspect ratio material within the resilient film.

31. The method of claim 27, wherein the at least one low aspect ratio material is in the range of 0.1% to 50% by weight of the total aqueous emulsion composition.

32. The method of claim 27, wherein the at least one low aspect ratio material is a pigment.

33. The method of claim 27, wherein the at least one low aspect ratio material is a glitter.

34. The method of claim 33, wherein the glitter is selected from the group consisting of MYLAR flakes, plastic flakes, metal flakes, and painted flakes.

35. The method of claim 27, wherein the alkyd resin comprises 30% to 80% of the total solids content of the aqueous emulsion composition.

36. The method of claim 27, wherein the alkyd resin is selected from the group consisting of a short oil alkyd resin, a medium oil alkyd resin, a long oil alkyd resin, a modified alkyd resin, and combinations thereof.

37. The method of claim 36, wherein the modification of the alkyd resin is selected from the group consisting of epoxy, acrylic, urethane, styrene, vinyl ester, vinyl ether, silicone, and combinations thereof.

38. The method of claim 27, wherein the alkyd resin is a long oil alkyd resin.

39. The method of claim 27, wherein the alkyd resin is an acrylic modified alkyd resin.

40. The method of claim 39, wherein the acrylic modified alkyd resin emulsion is in the range of 5% to 95% by weight of the total aqueous emulsion composition.

41. The method of claim 27, wherein the aqueous emulsion composition further comprises a latex emulsion comprising at least one latex resin.

42. The method of claim 27, wherein the aqueous emulsion composition penetrates into the surface, thereby preventing sling off of the film coating.

43. 41A method of forming a resilient, glossy sheen on a surface, comprising: applying to the surface an aqueous emulsion composition comprising an alkyd resin, a drier, and a plurality of at least one low aspect ratio material.

44. The method of claim 43, wherein the aqueous emulsion composition penetrates into the surface, thereby preventing sling off of the resilient film.

45. The method of claim 43, wherein the alkyd resin is selected from the group consisting of a short oil alkyd resin, a medium oil alkyd resin, a long oil alkyd resin, a modified alkyd resin, and combinations thereof.

46. The method of claim 45, wherein the modified alkyd resin emulsion is in the range of 5% to 95% by weight of the total aqueous emulsion composition.

47. The method of claim 43, wherein the aqueous emulsion composition further comprises a latex emulsion comprising at least one latex resin.

48. The method of claim 43, wherein the drier is a metallic drier.
